(19) United States
(12) Patent Application Publication
(10) Pub. No.: US 2005/0273822 A1
(43) Pub. Date: Dec. 8, 2005

(54) Video-on-demand satellite system

(76) Inventors: William L. Snell, Monmouth, OR (US); Samuel C. Yang, Orange, CA (US); Roberto Lopez-Aparicio, Bethesda, MD (US)

Correspondence Address: IPSOLON LLP, 805 SW BROADWAY, #2740, PORTLAND, OR, 97205, US

(21) Appl. No.: 11/024,500

(22) Filed: Dec. 28, 2004

Related U.S. Application Data
(63) Continuation of application No. 10/826,164, filed on Apr. 16, 2004, now abandoned.
(60) Provisional application No. 60/537,560, filed on Jan. 20, 2004.

(51) Int. Cl. H04N 7/173; H04N 7/20

(52) U.S. Cl. 725/64; 725/63; 725/72; 725/87

(57) ABSTRACT

A satellite video on demand system and method provide videos or other files on demand using a satellite in earth orbit. The satellite includes at least one uplink and multiple downlinks to multiple cells distributed over a geographic region. Multiple requests for video files from multiple users in multiple cells in the geographic region are received at a control station. The requests may include multiple requests from users in multiple cells for a first video file, and multiple other requests for one or more other video files from other users. The requests for the first video file are accumulated over a time period, and at least portions of the other video files are transmitted to the other users via the satellite during the time period. After the time period, the first video file is transmitted to the users who requested it with simultaneous transmissions over the satellite.

### FIELD OF THE INVENTION

The present invention relates to video-on-demand systems and, in particular, to such a system in which video-on-demand is delivered over via satellite.

### BACKGROUND AND SUMMARY OF THE INVENTION

Broadcast video systems, such as television, have traditionally provided entertainment or programs that are selected by networks and shown in accordance with a fixed schedule. All viewers who choose to watch a particular program watch it at the same time. A new type of entertainment systems provides video-on-demand (VoD) in which viewers can receive and watch a program when they want to watch it. An idealized VoD system would allow each viewer to watch a different program at the same time. VoD systems provide flexibility and convenience for viewers by disassociating their entertainment from the fixed schedule of a broadcast network.

Typically, a VoD system would include video servers that store and retrieve the program files, a transport and distribution network to carry the program files to the viewer, display devices (e.g., television sets), and receivers to transform the program files to a format suitable for the viewer's display devices.

In one prior implementation, video-on-demand is implemented and delivered via a cable television (CATV) system. In this prior implementation, a centralized architecture cable television VoD system serves programs directly to viewers through a CATV distribution network from a CATV central location. This approach provides centralized control, administration, and program security, but as more viewers request programs, the CATV transport network saturates and reaches capacity.

In another prior implementation, broadband VoD systems utilize the IP network of the Internet as the transport network. The architecture of such a system is similar to that of a CATV VoD system. The use of the Internet as the transport network can result in lower deployment costs. But as a public system that is not controlled by the broadband VoD provider, the Internet may subject to Denial of Service (DoS) attacks, download latency issues, and security breaches.

A limited VoD approach using wireless Over the Airwaves (OTA) transmission of program content is currently being implemented in a pilot program. Off-hours OTA transmissions load up program files in a local storage device at the viewer's location (e.g., home). Viewers select VoD choices from whatever programs have been loaded in local storage. The consumer is limited in choices by the capacity of the storage device and the low data rate of the OTA transmission, which limit how many program may be loaded during off hours.

Current systems suffer from several disadvantages. For example, current systems have limited bandwidth. As more viewers request programs, the transport and distribution networks saturate, resulting in a capacity limit or decreased performance. To increase the number of viewers who are served, network operators have to invest in transport and storage infrastructure, increasing the infrastructure costs. Distributed architectures result in a reduction of program choices in the distributed servers, and distributed servers and transportation through public networks decrease the security of the system.

Accordingly, the present invention provides satellite video on demand in which videos or other files are provided on demand using a satellite in earth orbit. The satellite includes at least one uplink and multiple downlinks to multiple cells distributed over a geographic region.

In one implementation, multiple requests for video files from multiple users in multiple cells in the geographic region are received at a control station. The requests may include multiple requests from users in multiple cells for a first video file, and multiple other requests for one or more other video files from other users. The requests for the first video file are accumulated over a time period, and at least portions of the other video files are transmitted to the other users via the satellite during the time period. After the time period, the first video file is transmitted to the users who requested it with simultaneous transmissions over the satellite.

The satellite video on demand of the present invention provides an effectively high-bandwidth transport pipe or network by exploiting statistical duplication of content such as by transmitting some video files while multiple requests for a common video file are accumulated. The system can provide nationwide or continental coverage via satellite without the need for multiple separate delivery centers or servers. Also, a large collection of programming content can be delivered from a large central server. The economics of satellite broadcast infrastructure means that new users can be added at virtually no cost, and the content can be distributed in a secure manner. Furthermore, flexibility in programming and pricing provides margin maximization.

Additional objects and advantages of the present invention will be apparent from the detailed description of the preferred embodiment thereof, which proceeds with reference to the accompanying drawings.

### BRIEF DESCRIPTION OF THE DRAWINGS

FIG. 1 is a schematic illustration of a satellite video-on-demand (VoD) system representing an operating environment of the present invention.

FIG. 2 is a simplified block diagram of one implementation of a VoD satellite.

FIG. 3 shows a representative spaced-apart cell pattern.

FIGS. 4A-4C illustrate different physical grid positions for cells.

FIG. 5 is an illustration of a virtual grid corresponding to a physical grid in the three positions

FIG. 6 shows a virtual grid arranged to cover the contiguous 48 states of the United States of America.

FIG. 7 is a graph in arbitrary units illustrating signal power at adjacent cell locations.

FIG. 8 illustrates an effective close-packed virtual grid that can be generated from loose-packed physical grid.

FIG. 9 is a flow diagram of a video-on-demand transmission method.

FIG. 10 is a graph showing effective throughput y as a function of c, the fraction of requests made for a common file.

FIG. 11 is a graph showing the effective throughput y as a function of cₖ, in which the virtual group k is the virtual group with the greatest number of dedicated-file requests.

FIG. 12 is flow diagram of a satellite VOD method.

FIG. 13 is a functional block diagram of a control station.

FIG. 14 is a simplified block diagram of an exemplary implementation of a user station.

FIG. 15 illustrates an alternative virtual grid beam pattern.

FIG. 16 is an illustration of an arrangement of alternative lobed cells.

FIG. 17 is a graph illustrating relative signal powers delivered by a lobed cell.

### DETAILED DESCRIPTION OF PREFERRED EMBODIMENTS

The proposed system delivers requested files to users by dynamically managing the queue of file deliveries. The file requests generated by users are processed by a queue engine located in the control station. The queue engine then controls the common and dedicated allocation of bandwidth and power used by the satellite to deliver files to users.

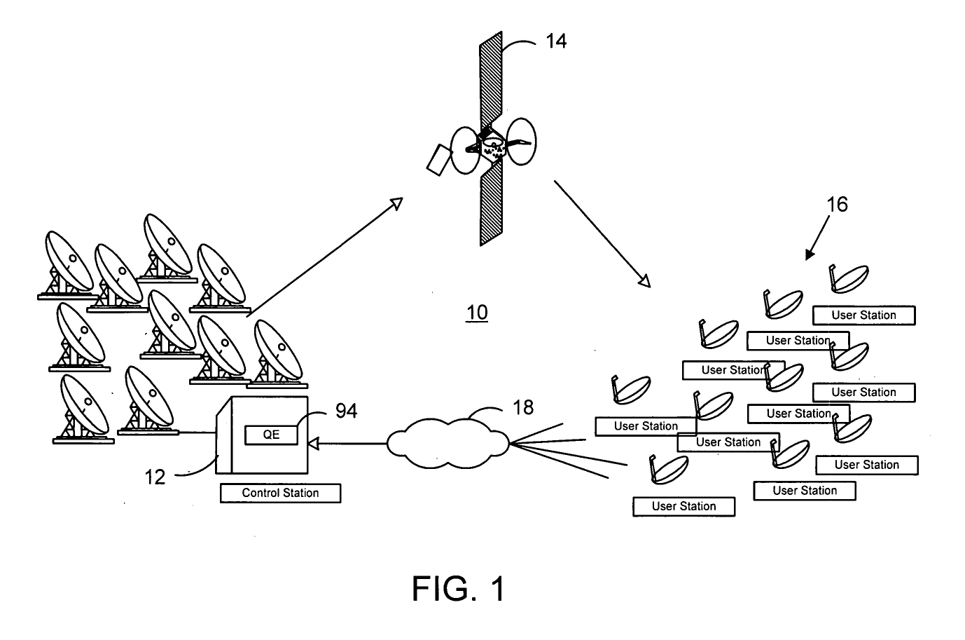

FIG. 1 is a schematic illustration of a satellite video-on-demand (VoD) system 10 representing an operating environment of the present invention. Satellite VoD system 10 includes a control station 12, a geostationary satellite 14, and multiple user stations 16 that are distributed over a geographical region. Control station 12 has a repository of data files such as video or audio files (sometimes referred to as “J files”) that may be of different sizes. Any one of user stations 16 may request one of the data files to be delivered to the user station via satellite 14. The user station 16 transmits its file request to the control station 12 over a control channel or communication network 18 separate from the satellite 14, such as using the public switched telephone network (PSTN).

The geographic region over which user stations 16 are distributed would typically be of a significant national or continental size, such as the continental U.S. (CONUS). In a distributed population, it can be assumed that within any time period T (e.g., several seconds or minutes) a group of users at different user stations 16 will typically request the same file, which is referred to as a “common” file. When control station 12 receives more than one request for a common file within a time period T, these requests are said to be temporally close to each other. A cluster of these users may be located in geographic proximity to one another, in which case these requests are said to be spatially close to each other. A file that is requested by only one user at a user station 16 is referred to as a dedicated file.

An ultra-high bandwidth satellite delivery system can transmit compressed files much more quickly than their normal playback time. Instead of serving the file requests immediately as they are received, control station 12 accumulates the requests in a queue. Control station can manipulate the temporal and spatial characteristics of the requests for common and dedicated files during the time period T to maximize the number of files delivered to users. The duration of the file delivery time via satellite 14 is short (e.g., several seconds or a minute or two), even for digital video files of a size of several gigabytes. Such fast file delivery time permits the queue optimization and maximizes utility of the delivery channel while providing “On-Demand” video service.

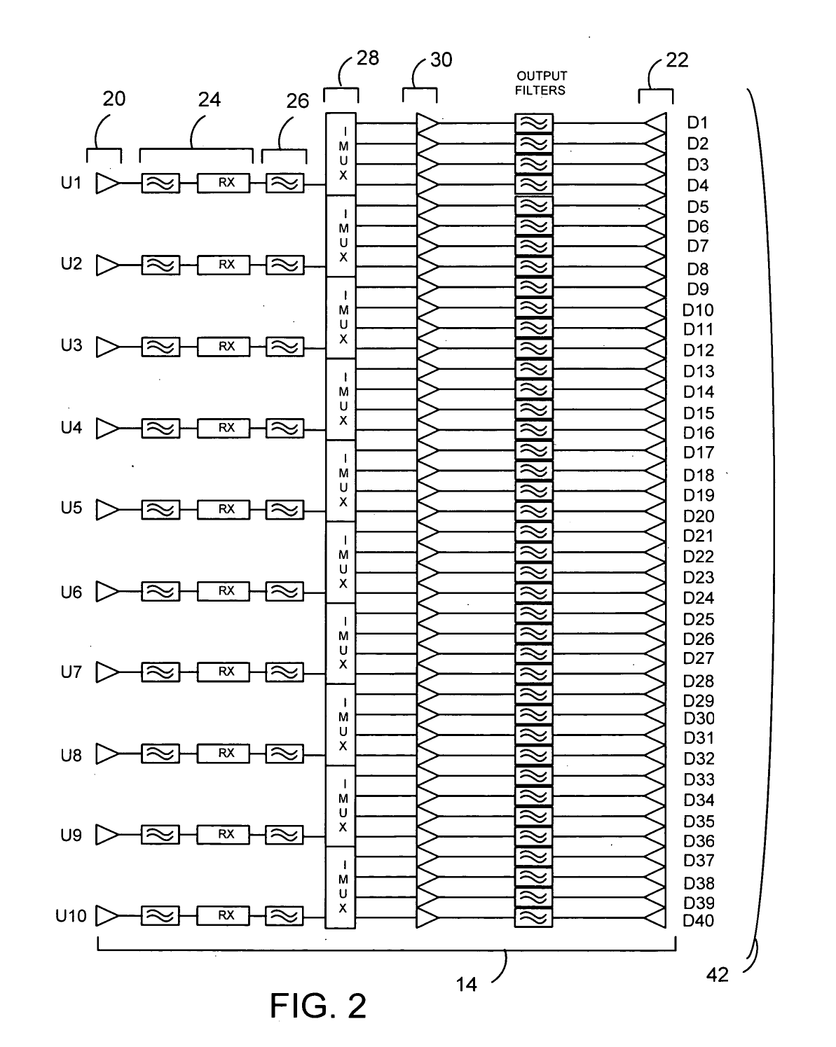

FIG. 2 is a simplified block diagram of one implementation of satellite 14 capable of receiving multiple (e.g., 10) uplink carrier beams U1-U10 and transmitting multiple (e.g., 40) downlink spot beams D1-D40 to corresponding cells in the geographic region. Satellite 14 includes multiple (e.g., 10) uplink horns 20 that communicate with an uplink antenna (not shown) in a conventional manner to receive corresponding uplink carrier beams. For example, each uplink carrier beam is transmitted from a control station 12 as an 8 GHz carrier with four 2 GHz RF channels.

Multiple transmitter or downlink horns 22 transmit, for example, forty 2 GHz downlink spot beams that are fed by the ten 8 GHz uplink carrier beams. In this implementation, for example, satellite 14 receives 40 uplink channels from 10 uplink beams that are transmitted from ten separate ground stations 12. Each uplink beam signal is passed through a filter/receiver combination 24 and a frequency downconverter 26 that downconverts the frequency of the uplink beam signal to a lower band.

Each channel on the uplink beam signal is demultiplexed by a 4-channel input multiplexer (IMUX) 28 into separate channels. A high power amplifier 30 amplifies each channelized signal and feeds it to a corresponding transmit horn 22 that produces one of the 40 downlink beams that are transmitted via a steerable satellite downlink reflector 42. The antenna beam pattern can be steered in several ways. Reflector 42 or parts of it can be steered, horns 22 can be steered, or attitude of satellite 14 can be altered to effectively steer the beam. For example, the attitude of satellite 14 can be altered by controlling momentum wheels of an attitude control system (not shown), as is known in the art. In one implementation, each downlink beam includes one 2 GHz-wide channel.

Transmit horns 22 form an array that cooperates with reflector 42 to produce a pattern of multiple downlink beams the provide spot-beam coverage. The spot-beam coverage produced by these downlink beams allows VOD satellite system 10 to increase system capacity through frequency reuse, provide higher antenna gain to support higher data rates, and direct beam transmission as required by a control queue, as described below in greater detail.

Satellite 14 is described as including horns 20 and 22 and a reflector 42. It will be appreciated, however, that in other implementations a satellite according to he present invention could employs other antenna technologies, such as a phased array or other antenna arrangements that direct a transmission to a particular user or a group of users.

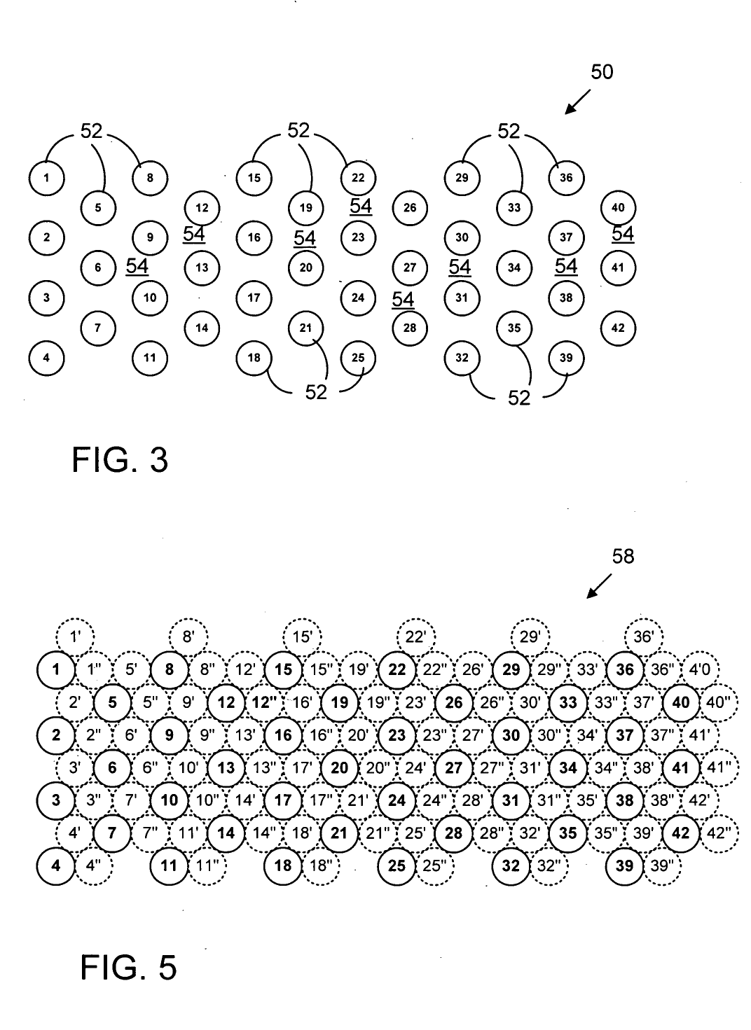

FIG. 3 shows a representative spaced-apart cell pattern or “physical grid” 50 of cells 52 (only selected ones indicated by reference numerals) that are formed by the downlink spot beams in the geographic region. Cells 52 are individually numbered in the diagram to distinguish them from each other. Physical grid 50 forms an open array in which adjacent cells 52 are spaced-apart from each other and have between them interstices 54 (only selected ones indicated by reference numerals). In this illustration, forty-two cells 52 are formed by or receive 42 corresponding downlink spot beams from a satellite of the present invention having two more downlink beams than satellite 14 in the implementation of FIG. 2. It will be appreciated that VOD satellite 14 could generate generally arbitrary numbers of spot beams for a corresponding arbitrary number of cells 52.

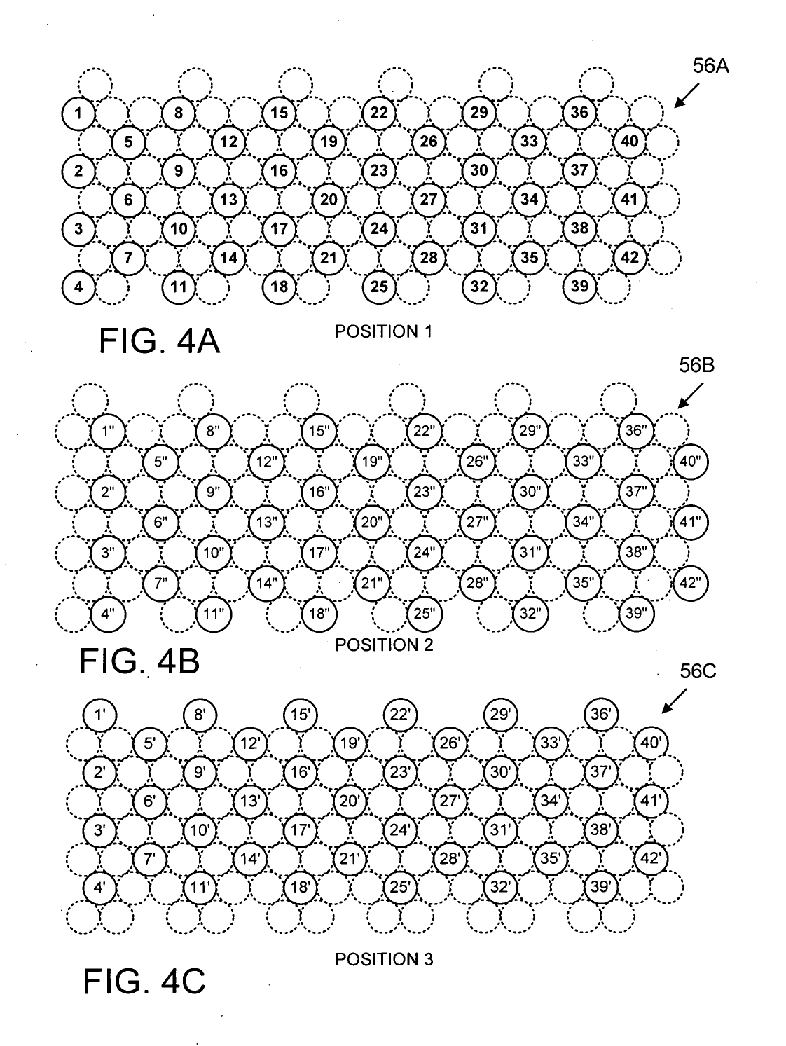

With steerable downlink reflector 42, VOD satellite system 10 can steer or shift physical grid 50 of cells 52 over a geographical region. In one implementation, steerable downlink reflector 42 is configured to steer or shift physical grid 50 between three different positions. FIGS. 4A-4C are illustrations of spaced-apart physical grid 50 being directed to three different positions 56A-56C, respectively. In each of FIGS. 4A-4C, cells 52 corresponding to physical grid 50 are numbered sequentially, and positions of the cells in the other physical grid positions are unnumbered. FIGS. 4A-4C illustrate how different positions of steerable downlink reflector 42 can direct physical grid 50 to different positions 56A-56C at different times.

FIG. 5 is an illustration of virtual grid 58 corresponding to physical grid 50 in the three positions 56A-56C of respective FIGS. 4A-4C. Virtual grid 58 represents a union or total of all the positions 56A-56C of cells 52. Virtual grid 58 in this implementation includes 126 virtual cells, of which up to 42 receive downlink signals at a time. Physical grid 50 is the actual beam pattern generated by the 42 beams in one reflector position. Virtual grid 58 may be generally fixed, but physical grid 50 can move depending on the reflector position. For example, a reflector position and its corresponding effective coverage area may be chosen to capture as many users as possible who have requested a common file.

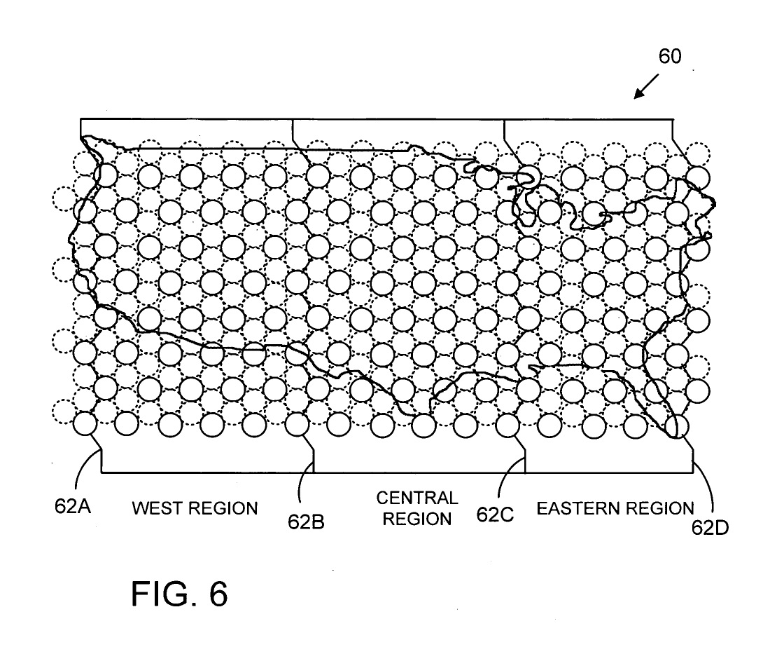

FIG. 6 shows how such a virtual grid 60, having a different number of virtual cells than virtual grid 58, can be arranged to cover the contiguous 48 states of the United States of America with three inter-grid spot beam movements. Such inter-grid spot beam movements can be employed alone or in combination with intra-grid movements, which are illustrated in FIGS. 4A-4C. Spot beam partitions and groupings along vertical axes 62A-62D serve to provide services along local time zones to further exploit temporal and geographical separation of consumer demand for content files. It will be appreciated that the illustration of virtual grid 58 with respect to the 48 states is merely an example. A virtual grid 58 could alternatively be applied to any other geographical region or could employ a different virtual grid arrangement.

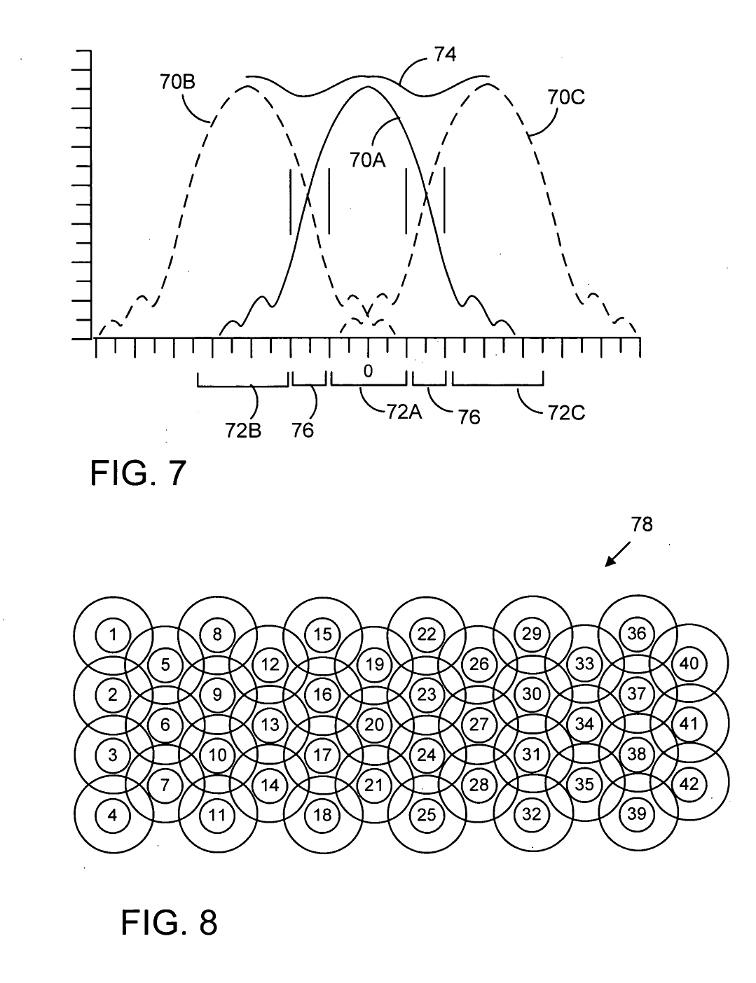

FIG. 7 is a graph in arbitrary units illustrating signal power 70A-70C at respective adjacent cell locations 72A-72C in an open physical grid 50. Cell locations 72A-72C correspond to a triangular triad of cells 50 for one position of downlink reflector 42. For example, the cells 50 numbered 13, 16, and 17 in any of FIGS. 4A-4C could represent such a triad. As is known in the art, signal power extends beyond each of cells 72A-72C as signal power that is less than a predetermined threshold. With each off cells 72A-72C receiving the same downlink signal, signal power outside and between cells 72A-72C constructively interferes to provide a combined downlink signal 74 that extends over interstitial regions 76 between adjacent pairs of cells 72A-72C.

FIG. 8 illustrates an effective close-packed virtual grid 78 that can be generated from loose-packed physical grid 50 when all cells 52 for a given position of downlink antenna 42 receive the same downlink signal in the manner described with reference to FIG. 7. Effective close-packed virtual grid 78 represents a broad coverage mode of operation in which a common file is transmitted to all 42 cells 52. The broad coverage mode of operation produces a broad, generally contiguous coverage area and delivers the common file to all users in the region, including users in the interstitial areas between cells (e.g., areas 54 in FIG. 3). In addition, depending on the locations of users (i.e., cells 52) to which a common file is being transmitted, satellite 14 may be directed to position its cells 52 in one of three positions 56A-56C to produce one of three broad effective coverage areas.

The satellite downlink reflector 42 transmits the multiple downlink beams and can produce nearly uniform power distribution between the cells 52. Interstitial areas between cells 52 can combine the signal power received at adjacent cells 52 and attain virtually the same signal power as the cells. In this diversity-combining scheme, transmissions to adjacent cells 52 are identical and in-phase with common file transmission.

Typically, a single downlink beam is used to deliver a dedicated file to a user located in a cell 52 corresponding to a beam, while multiple downlink beams are used to deliver a common file to users who have requested the file and are located in a wider coverage area. In some instances, all downlink beams could be used to deliver a common file if users who requested the file are located throughout the coverage area.

A selective coverage mode of operation may be used when only a few users have requested a common file. The common file is transmitted to those users using spot beam patterns and reflector positions to access the cells 52 where the users are located. In one case, it may be desirable to transmit the common file through individually addressable downlinks directed to selected cells 52. If necessary, the downlink beams may be moved to other positions in the virtual grid 78 as intragrid movements. The common file may be transmitted using the same or different beams. Alternatively, for users located in an interstitial area between two adjacent cells 52 of one reflector position, the common file may be transmitted to both adjacent cells 52 simultaneously so that the users in the interstitial areas between cells 52 coherently combine the power of signals received from the beams to receive the common file transmission.

An aspect of the present invention is an appreciation that the file delivery system using a communications satellite may provide improved matching of spectral resources to the expected file request requirements in different geographical areas using cells of different sizes. In one implementation, antenna beams may be formed with sizes that are generally proportional to population density or other relevant demographics or considerations such as expected signal fade characteristics.

In a dedicated coverage mode, a single user requests a file and over the time period T no other user in its vicinity requests the same file. In this case, satellite video on demand (VOD) system 10 uses one beam at one reflector position to deliver the dedicated file to that single user.

The present invention may employ one or more geostationary satellites 14 adapted for high-data rate transmission, dedicated communications payload design with a high gain steerable reflector 42, and flexible downlink transmission patterns. High data rate is achieved by exploiting an ultra-high bandwidth frequency utilization plan and frequency reuse through spot beam technology and orthogonal polarizations.

A conventional satellite has an allocated spectrum bandwidth that is typically segregated into uplink receive and downlink transmit frequency bands and reused in two orthogonal polarizations. Each of those frequency bands is further segregated into multiple channels with frequency guardbands, reducing the effective bandwidth.

In contrast, satellite VOD system 10 uses different frequency bands for receiving and transmitting signals. In one implementation, uplink signals are transmitted from control centers 12 to satellite 14 in V band, and downlink signals are transmitted in the Ka band. Alternatively, the O band can be used for uplink signals with the V band being used for downlink signals, or plural such pairings can be used in combination. Because satellite 10 does not transmit downlink signals in the same frequency band in which uplink signal are received, the frequencies allocated for transmission in the uplink band can be used to double the downlink bandwidth. This provides single-mode, multiband operation

Also, interference with other satellites may be minimized by forming downlink reflector 42 with a large aperture to provide high-gain and to create tightly focused small spot beams with high gain roll-off and small side-lobes. Interference with satellites directly opposite on the geostationary arc is not possible because the earth blocks the line of sight transmission. Interference with other satellites is minimized by aiming the transmit energy away from the geostationary arc. Northern hemisphere ground targets are several degrees (e.g., 4-7 degrees) above the equator in satellite coordinates. Antenna gain several degrees off boresight is small, which provides minimal signal spillover to other satellites in the geostationary arc. Possible interference is further minimized by controlling the antenna side-lobes by apodization and by the orbit geometry, which locates the satellites closest to the earth's limb the farthest from the satellite, with a large path loss.

Control stations 12 stores the locations of users who request file delivery and can individually address each beam to deliver common and dedicated files using any of the broad coverage mode, the selective coverage mode, or the dedicated mode. The spot beam to reach a desired user station 16 in a cell 52 can be selected by controlling the position of reflector 42 and the channel frequency.

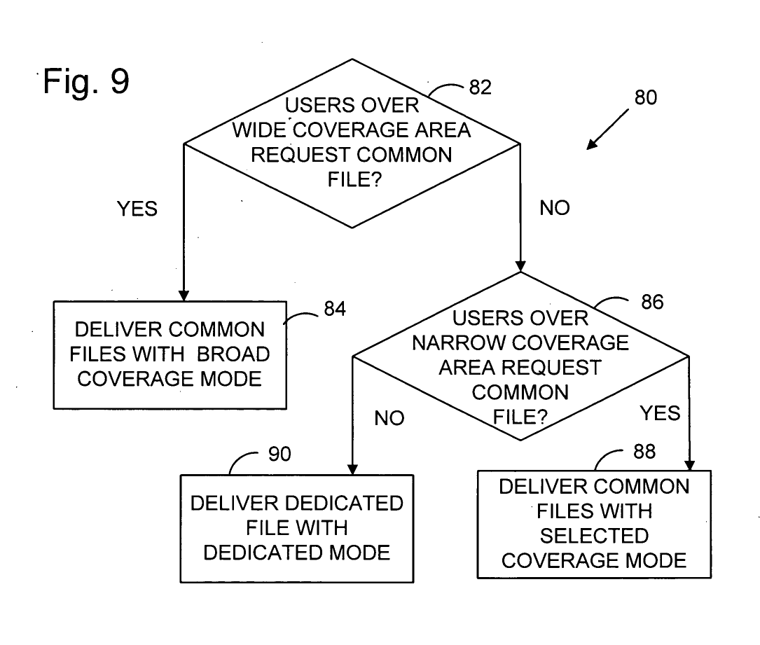

FIG. 9 is a flow diagram of a video-on-demand transmission method 80 for selectively transmitting data (i.e., video files) to arbitrary numbers of cells 52.

Step 82 is a query to determine whether users over a wide coverage area have requested a common file (i.e., a VOD video) over a time T. If so, step 82 proceeds to steps 84 and otherwise proceeds to step 86.

In step 84 common files are delivered by using a broad coverage mode in which a common file is transmitted to a wide effective coverage area. As described, multiple adjacent downlink beams are used. A reflector position and antenna beams are chosen to capture as many as possible of the users who have requested the common file.

Step 86 is a query to determine whether users over a selected coverage area of multiple cells have requested a common file (i.e., a VOD video) over a time T. If so, step 86 proceeds to steps 88 and otherwise proceeds to step 90.

In step 88 a selective coverage mode is used to deliver a common file that has been selected by users in only a few locations. For locations where no direct beam is available to serve the limited locations using the selective coverage mode, antenna or horn movement can reposition the reflector to provide a direct beam or the file can be delivered by coherently combining signal power from adjacent cells 52.

In step 90 a single user requests a unique file, and over the time period T no other user in its vicinity requests the same file. In this case, the system 10 uses one beam at one reflector position to deliver the dedicated file to that single user.

Control stations 12 employ a queue engine 94 (FIG. 1) to transmit files using different beams and reflector positions in response to file requests generated by users. The queue engine 94 functions to maximize the numbers of users receiving their files while minimizing the aggregate wait time of all users, subject to the constraint that no user's wait time can exceed a maximum value Tₘₐₓ. In doing so, the queue engine 94 allows control stations 12 to direct whatever file to whichever cell at whichever reflector position in order to maximize the number of users served in a given period.

The queue engine 94 of control stations 12 optimizes the delivery of files based on the following set of inputs: (1) Physical locations (e.g., cells) of users who have requested files, which locations are known to control stations 12 based on the identities of the requesting viewers, (2) the file j (i.e., VOD video) requested by user i, and optionally (3) the received signal strength measured at the user station 16 of the requesting user. The received signal strength is used to estimate the signal fade experienced at that user station 16.

Based upon these input factors, the queue engine 94 delivers the following outputs: a transmission start time and end time for the file j, identification of a downlink beam used to transmit file j, a reflector position, and a beam power control. The identified downlink beam is selected with respect to a particular uplink beam/channel combination for the uplinked file i.

Broadcast systems have traditionally provided entertainment or program files that are selected by networks and shown in accordance with a predefined schedule. All consumers who choose to watch a particular program have to watch it at the same time.

Determinations by control stations 12 of which files to transmit at what times are predicated by the output of queue engine 94, which makes real-time decisions based on statistical characteristics of user requests. Tₘₐₓ is a parameter of the queue engine 94 corresponding to an effective maximum user wait time. Conventional queuing theory dictates that as one increases Tₘₐₓ, the number of users served will also increase.

While there are users who will request the same file (i.e., a common file), other users will request different and distinct files (i.e., dedicated files). While it accumulates requests for the common file, the queue engine 94 will commence delivery of individual files to those users who have requested dedicated files. Thus, the queue engine 94 leverages the time used to accumulate common-file requests by delivering dedicated files. While the common-file requests are being accumulated, the queue engine commands transmissions of dedicated files. After serving those users who have requested dedicated files by using more than one transmission, the queue engine 94 then serves the accumulated common-file requests using one single transmission. This manner of operation provides a dynamic queue management that avoids making individual transmissions of a file (i.e., common file) that has been requested more than once in a given time period T. This avoidance frees up spectral resources that can be used to transmit additional dedicated files and serve more users.

In addition, queue engine 94 may deliver an incomplete portion of a dedicated or common file if doing so will decrease the aggregate wait time of all users. If it elects to initially deliver an incomplete portion of a dedicated or common file to a user or users, the queue engine 94 delivers the remaining portion of file preferably before the earlier-delivered portion is completely viewed.

Each downlink beam transmits an RF channel containing files transmitted one after another. At the end of a file transmission, the queue engine 94 may command the reflector to change to a new position in order to direct the next file to be transmitted to a different virtual cell. The movement of the physical grid 50 within the virtual grid (i.e., virtual cells) based on commands from the queue engine 94 is referred to as intra-grid movement.

The physical grid 50 shown in FIG. 3 and its broad effective coverage area 78 shown in FIG. 8 may not be large enough to cover a large geographic region (e.g., the contiguous U.S.). In such a situation, the physical grid 50 may be repositioned to a non-overlapping location by changing the reflector position by a large amount. For example, the physical grid may be adequate to cover at one time only one region of the United States (e.g., the western U.S. region). In order to cover eastern U.S. region, queue engine 94 commands satellite 14 to move the entire physical grid 50 eastward. After the physical grid 50 is directed to or anchored on the eastern U.S. region, file delivery operations can then begin to deliver files to that region, with or without intra-grid movements.

In general, the number of inter-grid movements is minimized because the system exploits the time-of-day difference across multiple time zones. For example, when it is 8:00 pm on the U.S. east coast, the east coast originates many file requests while the U.S. west coast (5:00 pm) would originate fewer file requests. During this time, the physical grid 50 would be directed most of the time to the U.S. east coast to serve requests there. At 11:00 pm on the U.S. east coast, the number of requests for files there would typically have decreased, while file requests from the U.S. west cost would have increased toward their heaviest volume during the 8:00 pm time period. The physical grid 50 would then be directed for a time toward the U.S. west coast.

It will be appreciated that inter-grid movements can be eliminated by adding another satellite whose physical grid is solely anchored on a different time zone region, for example.

Control stations 12 employ the queue engine 94 to accumulate common requests to effectively multiply the throughput of the system. The following description illustrates how controlling and queuing content requests in queue engine 94 can increase effective system bandwidth. As a baseline case, a single broad beam using one RF channel is assumed to cover a region of the continental United States (e.g., western U.S. region). The data rate deliverable over the broad beam is r (bits-per-second, bps). Since this hypothetical satellite only has a single broad beam, it is assumed that all available DC power onboard the satellite is feeding a single high power amplifier, which in turn drives the broad beam.

Each file is identical in size s (bits), and over time T seconds there are D requests made by users located in the broad coverage beam. The time x (seconds) it takes to serve those D requests is
x=s/rD (1)
Given x, the effective throughput y (bps) of the system over T is then

$$y = \frac{sD}{( s / r ) D} = r \qquad ( 2 )$$

This result indicates that throughput is the same as data rate when files are served sequentially in a queue without regard to common files.

The following is the analysis of a second case in which the system 10 exploits common-file requests, but still uses a single broad beam. Over time T there are D requests, and dⱼ is the number of requests for file j. With J being the total number of available files:

$${\sum }_{j = 1}^{J} {d}_{j} = D \qquad ( 3 )$$

The time x it takes to serve those D requests is then

$$x = \frac{s}{r} {\sum }_{j = 1}^{J} a ( {d}_{j} ) \qquad ( 4 )$$

where a(.) is a binary function that yields a 1 if its argument is non-zero and yields a 0 if its argument is zero.
The effective throughput y of the system over T is then

$$y = \frac{rsD}{s {\sum }_{j = 1}^{J} a ( {d}_{j} )} = \frac{rD}{{\sum }_{j = 1}^{J} a ( {d}_{j} )} \qquad ( 5 )$$

Although Equation (5) is correct, several assumptions can simplify the calculation of Equation (5). One assumption is that there is only one file requested by more than one user (i.e., one common file), and the rest of the files requested are different and distinct (i.e., dedicated files). If c is the fraction of requests made for a common file, then the time x it takes to serve those D requests is
x=s/r+(1−c)s/rD=s/r[1+(1−c)D] (6)
Thus, the effective throughput y of the system over T is the

$$y = \frac{rsD}{s [ 1 + ( 1 - c ) D ]} = \frac{r}{\frac{1}{D} + ( 1 - c )} \qquad ( 7 )$$

Note that if the number of requests over T is large (i.e., D>>1), then

$$y \approx \frac{r}{1 - c} \qquad ( 8 )$$

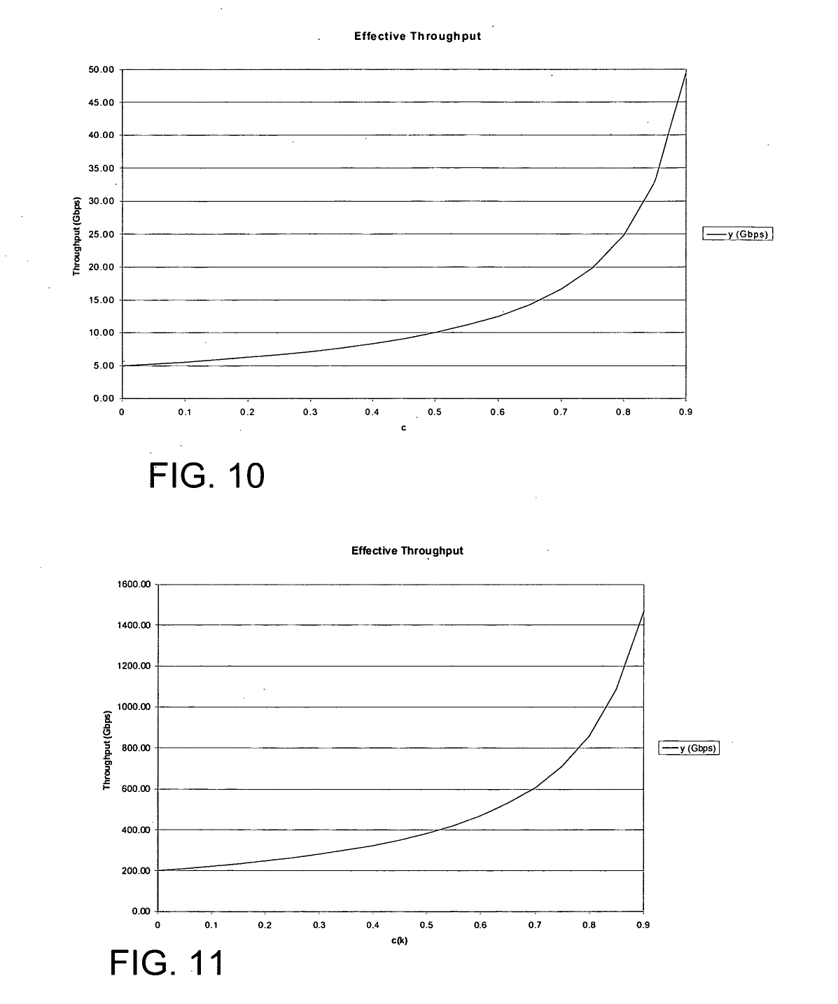

FIG. 10 is a graph showing effective throughput y as a function of c, the fraction of requests made for a common file. For purposes of illustration, the graph of FIG. 10 is generated based upon a data rate r of 5 Gbps Number of requests D equal to 1,000

As expected, when c=0 (i.e., when all file requests are unique and are for dedicated files), the throughput y is equal to the baseline data rate r (5 Gbps). As the fraction of common-file requests c increases, the throughput y increases as well. At c=0.7, the throughput more than triples at 16.6 Gbps. Note that this is based upon the illustrative use of a broad beam. In general, the greatest gain in throughput is extracted when c is large (i.e., most of the file requests are for a common file).

As another illustration, the system is now considered to include an ensemble of K (e.g., 40) physical beams. Each beam and the entire physical grid can occupy one of three positions using reflector movements, for example. Each physical beam is assumed to include one RF channel, and each physical beam can deliver a data rate of r. With the satellite now having 40 physical beams, all available DC power onboard the satellite is divided among 40 high power amplifiers. Although the output power is now lower, the antenna gain of the physical beam is now higher due to a smaller beam width.

As a result, the effective isotropic radiated power (“EIRP”) of a physical beam of this case is the same as EIRP of the broad beam of second case. As is known in the art, effective isotropic radiated power (expressed in decibels) is the ratio between the radiated power density and the power density radiated by a one-watt transmitter from an isotropic radiator. Thus the data rate is still at least r. Although some increase in r is possible in this case, using the same r yields a conservative estimate of throughput.

Each physical beam can illuminate one of three virtual cells. A group of three virtual cells is called a virtual group. Thus, each physical beam is responsible for covering three virtual cells or a virtual group. Users in each virtual group k originate d_{k,j} requests (1<k<K) for file j, and

$${\sum }_{j = 1}^{J} {\sum }_{k = 1}^{K} {d}_{k , j} = D \qquad ( 9 )$$

The time x it takes to serve those D requests is then

$$x = \frac{s}{r} {max}_{k} \{ {\sum }_{j = 1}^{J} a ( {d}_{k , j} ) \} \qquad ( 10 )$$

The effective throughput y of the system over T is then

$$y = \frac{sD}{\frac{s}{r} {max}_{k} \{ {\sum }_{j = 1}^{J} a ( {d}_{k , j} ) \}} = \frac{rD}{{max}_{k} \{ {\sum }_{j = 1}^{J} a ( {d}_{k , j} ) \}} \qquad ( 11 )$$

Again, certain assumptions can simplify the calculation of Equation (11). Fir example, it is assumed that there is only one file requested by more than one user (i.e., one common file), and the rest of the files requested are different and distinct (i.e., dedicated files). In each virtual group, fraction cₖ of requests are for a common file (1<k<K). The common file can be delivered using a single transmission using all K (=40) physical beams (see FIG. 8). The time x it takes to serve those D requests is

$$x = \frac{s}{r} + \frac{s}{r} {max}_{k} \{ ( 1 - {c}_{k} ) {d}_{k} \} = \frac{s}{r} \{ 1 + {max}_{k} \{ ( 1 - {c}_{k} ) {d}_{k} \} \} \qquad ( 12 )$$

Correspondingly, throughput is then

$$y = \frac{sD}{\frac{s}{r} \{ 1 + {max}_{k} \{ ( 1 - {c}_{k} ) {d}_{k} \} \}} = \frac{rD}{1 + {max}_{k} \{ ( 1 - {c}_{k} ) {d}_{k} \}} \qquad ( 13 )$$

Note that Equations (12) and (13) assume that cₖ is nonzero. If the number of dedicated-file requests is large, then

$$y \approx \frac{rD}{{max}_{k} \{ ( 1 - {c}_{k} ) {d}_{k} \}} \qquad ( 14 )$$

The above relationship would be exact if all requests are for dedicated files (i.e., cₖ=0).

FIG. 11 is a graph showing the effective throughput y as a function of cₖ, in which the virtual group k is the virtual group with the greatest number of dedicated-file requests. The graph of FIG. 11 is based upon the following exemplary parameters:
Data rate r=5 Gbps
Number of requests D=1,000.
Number of requests (originated from virtual group k) dₖ=24.
Number of physical beams (and of virtual groups) K=40.

As expected, when cₖ is 0 the throughput is 200 Gbps, which is 5 Gbps multiplied by 40 (beams). However, throughput increases as cₖ increases. Note that FIG. 11 is generated based on the assumption that virtual group k is one, which corresponds to the maximum number of dedicated-file requests. When cₖ=0.6, which corresponds to 10 out of 24 requests from virtual group k being for dedicated files, the throughput is 470 Gbps. As cₖ increases, chances are that throughput will eventually be capped because another virtual group will become the one that produces the maximum number for the term (1−cₖ)dₖ. However, if the maximum fraction of dedicated-file requests is about 0.3 to 0.4, then throughput can be expected to be maximized between about 610 Gbps to 470 Gbps. This assumes that the number of requests originating from each virtual group is identical (e.g., 24 in this illustration). In actuality, dₖ works in concert with cₖ to produce the maximum number of dedicated-file requests, as represented by Equation (13).

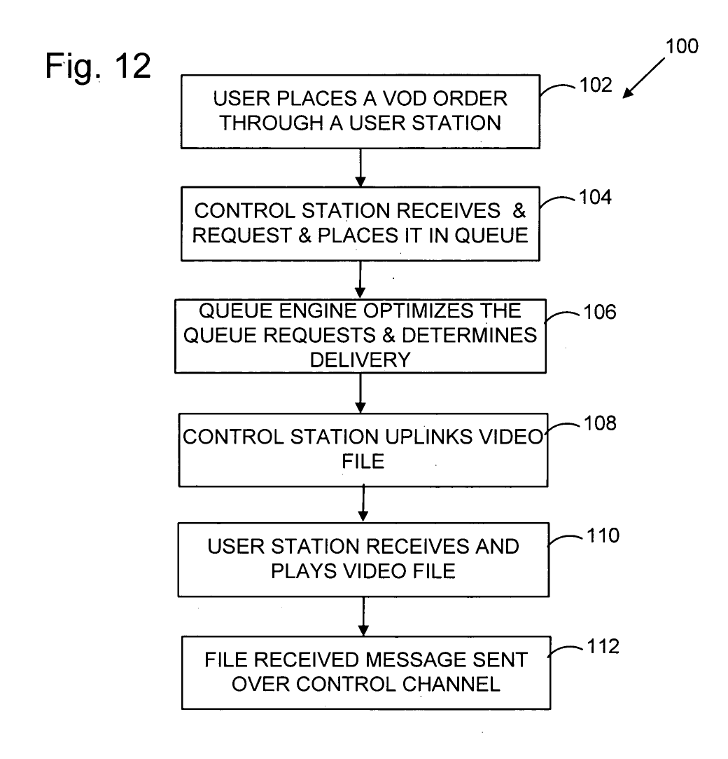

FIG. 12 is flow diagram of a satellite VOD method 100.

In step 102 the file (i.e., video) delivery process begins with the user or customer placing a VOD order through a user station 16. In one implementation, the user may activate an order mode which then displays a list of file or video choices available to the customer. The user selects a file or video, such as by highlighting and then acknowledging a desired selection. The selection is communicated to the control center as a formatted order message that includes authentication and identification information. The order message is transmitted through a modem using an order channel (i.e., communication network 18 (FIG. 1)), which may be or may include a wireless paging network, a public network like a PSTN, or the Internet.

In step 104 the control station receives the order message, authenticates it with reference to the identified user, and places the request in an order queue.

In step 106 the queue engine optimizes the queue requests and decides what file to deliver and to which user cluster to deliver it.

In step 108 the control station uplinks the file to the satellite using a specific uplink beam and a specific channel. This unique uplink beam and channel combination corresponds to a particular downlink beam. The queue engine also commands the satellite to direct the downlink beam containing the file transmission to the cluster of users who have requested the file.

In step 110 the user station receives the file, converts the signal to a format compatible with the television display device, and begins delivering the file to the display device.

In step 112 the user station send sends a message over the control channel 18 to complete the transaction when a complete file has been successfully received.

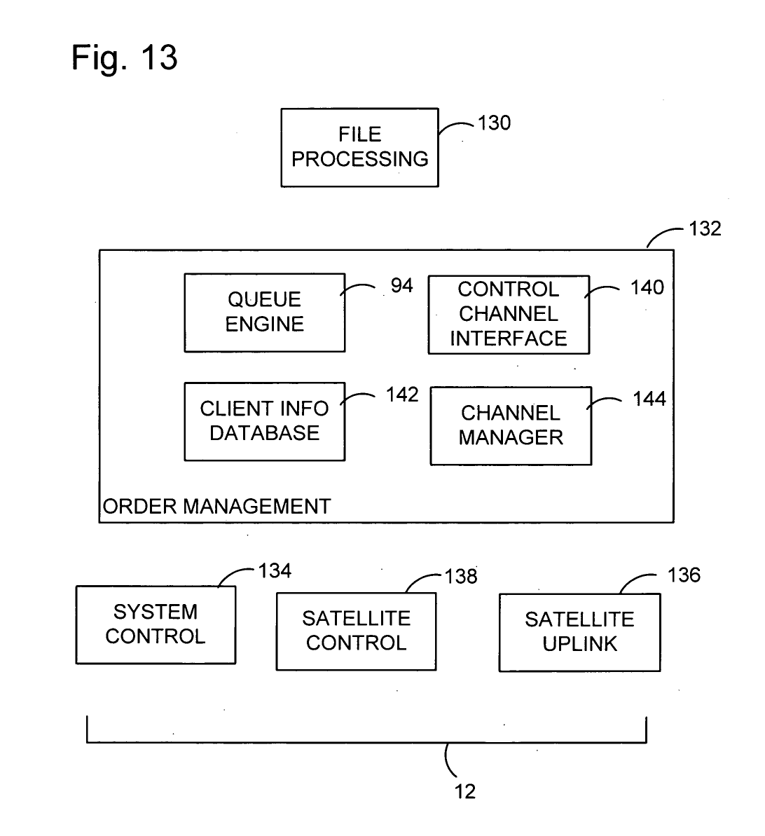

FIG. 13 is a functional block diagram of a control station 12 illustrating major control station functions of file processing 130, order management 132, system control 134, satellite uplink 136, and satellite control 138. It will be appreciated that functions 130-138 or portions of them may be performed at one or multiple physical locations that may be located together or at widely separate geographic locations.

File processing 130 provides operations that prepare a file or digital video for use with satellite VOD system 10. Some of these operations may include any or all of digitization, digital image restoration, digital watermarking, frame scrambling, compression, and encryption. File processing 130 may use asymmetrical encryption and compression in which encryption and compression processing require greater computing resources than the respective decryption and decompression. Asymmetrical encryption algorithms provide superior security, and asymmetrical compression algorithms provide significantly higher decompression speeds at user terminals where processing power is relatively modest relative to control station 12.

File processing 130 stores the files or videos in a database for use by satellite VOD system 10. Each file will be stored with additional information useful to the system and of interest to the clients, like movie credits, movie reviews and other movie information, licenses for billing and payment purposes, and an audit trail of transactions.

Order management 132 control the operations that execute a transaction, namely transmission of a VOD video over satellite system 10 in response to a request for a user or customer. In one implementation, transaction operations begin at a control channel interface 140, which is a communications channel over which control station 12 receives and sends formatted messages to user stations 16. Messages from user stations 16 include a user authentication preamble, a service request, a power reading, and system status indicators. Control channel interface 140 is encrypted to protect the contents of the message.

Order management 132 also employs a client information database 142 that includes the following fields:
Authentication code to verify the identity of the originator of the messages (i.e., the system user or customer)
Location code to determine the antenna cell to use to reach the customer. Alternatively, coordinates, telephone area code, or zip code may be used instead of a location code.
Billing information
Transaction Audit trail of orders and the watermarks associated with those orders. Watermarks are identifying codes discreetly incorporated into videos or files to identify the source if illicit copies of a video or file are created.
Encryption Keys used for access authorization codes so that the user or customer can decrypt the file or video
System status and other service log information

Authenticated orders received by order management 132 are placed into the service optimization process of queue engine 94. A channel manager 144 reads directives from queue engine 94 and performs the following operations:
Retrieves the files from the database 142 and prepares them for service with the appropriate watermark, scramble, or encryption processes.

Generates access authorization codes for each receiver.

Generates Antenna Codes and Power Control commands.

Assembles Delivery Queue containing ordered transmission packages of Antenna Cell Pattern commands, Power Level commands, Authorization Codes, and Content Files
Manages the Delivery Queue by beginning transmission of the messages at the designated uplink times.

Control station 12 can transmit any or all of the following message files to the user stations 16:
Content or video files ordered by the client
Catalog of video files, updated periodically
Previews and announcements, which may include commercials.
Control signals, which may include key distribution, algorithms, rights revocations, and system queries messages
   The messages may be ordered via a dynamic priority allocation between common video files, dedicated video files, orders retransmits, control signals, previews and announcements, and catalogs.

Control station 12 monitors transactions at the user terminals 16 via the control channel 18. The user terminals 16 transmit a transaction complete message when a complete video file has been received. Completed transactions trigger billing, royalty license payment, and audit trail operations. Unsuccessful transactions trigger retransmission requests. Control station 12 can query the status of the user terminal 16 and, if deemed necessary, take its requests out of the queue to prevent multiple retransmissions.

System control operations 134 performs several functions:
Monitor and maintain the operational status of the system.
Maintain current information on the path loss to each cell/user terminal.
Maintain current operational status of user terminals.
Generate and allocate keys and file processing algorithms
Prepare service revocation messages.
Prepare user terminal system update messages.
Perform quality of service calculations.
Emulate the queue to test the performance of different queue optimization algorithms.
Perform manual overrides of the queue engine.

Satellite uplink operations 136 transmit the content of the delivery queue as modulated RF carriers using a number of satellite uplink antennas. To reduce the power necessary to transmit to the satellite at high frequency bands, uplink antennas will be located in one or more regions of low humidity to reduce atmospheric signal path loss.

Satellite control operations 138 perform satellite telemetry, tracking, and command (TT&C), engineering, orbital mechanics, and other functions necessary to maintain the satellite stations operating properly. The satellites communicate with the control station in a manner known in the art.

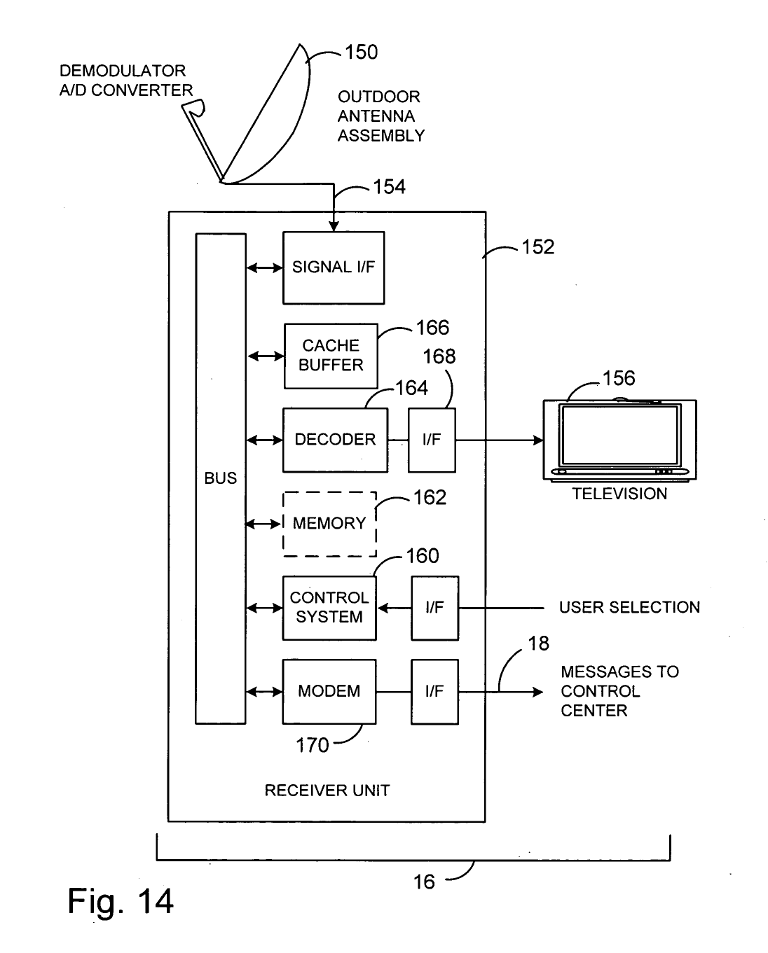

FIG. 14 is a simplified block diagram of an exemplary implementation of a user station 16, which includes two main units, an external antenna unit 150 and a receiver unit 152. Units 150 and 152 are connected to each other by a high-speed cable 154 carrying signal and power. Receiver unit 152 can be connected to a display unit 156 (e.g., a television) or can be built into a television display unit (not shown) to provide enhanced content security and user convenience.

External antenna unit 150 receives a signal at a high-frequency band (e.g., Ka-, A-, or O-band). For example, the antenna feed 154 has an ultra-high bandwidth multiband front end that demodulates the satellite signal into a high-speed digital data stream. The demodulation implements highly efficient channel demodulation and decoding techniques to achieve 2.8-3 bits/Hz on the channel with a E_{b}/Nₒ of approximately 5 dB. The feed also provides an RF signal strength indication to receiver unit 152. With multiple feeds and antenna designs, antenna unit 150 may receive signals from multiple satellites 14.

The receiver unit 152 performs several functions, including converting the antenna signal into an electrical signal compatible with display on television 156. In combination with the television 156, receiver unit 152 allows the user to select the file to receive from a list of files or videos at available from control station 12. Receiver unit 152 may perform any or all of the following functions, including placing video orders with control station 12 via control channel 18, providing quality of service feedback to control station 12 via control channel 18, safeguarding the security of the video files, permitting the user to store files and play them back at another time, receiving maintenance, troubleshooting, and revocation signals from control station 12 to disable receiver unit 152 in case of a security breach.

Receiver unit 152 includes and is controlled a control system 160 that includes a low level boot program and an operations control program that are stored on a memory 162. The boot program performs self-tests, stores system configuration, and loads the operational program. Operations programs can be loaded remotely into the receiver unit 152 via the control channel 18, the satellite downlink channel, or both. For security purposes, the boot program can only be loaded at a maintenance facility.

Once being activated and becoming part of system 10, each receiver unit 152 acquires a unique system configuration from the control channel 18. The operations control program runs the user interface and permits the user to choose operating modes from menus presented on the display device 156. Such modes may include: setup (display, system test, troubleshooting, power level), file lists and file guides and reviews, sort and search features, locks (parental, station, budget), orders, timer, messages, optional recordings, and account access. The control program may also implement the security features and execute the programs required by a decoder 164.

The received digital data is buffered and captured by a cache 166 of high-speed solid-state memory. Memory 162 may store the following types of information or include the following memory segments:
System memory storing user information and channel decoding information. User information may include identification and authentication codes, location information, and parameters for the communications channel to the control station. Channel decoding information may include decompression algorithms, watermarking algorithms, decryption algorithms, and keys. The contents of the system memory can be periodically updated by the control station 12.
Program memory that may include a file or movie catalog, a price list, movie previews, announcements, games, and other forms of entertainment.

Content memory storing the downloaded file or archived files. Disk drive storage in memory 162 can function to increase storage capacity, support decoding operations, or permit versatile playback options. Cache buffer 166 stores the demodulated data.

Cache buffer 166 is formed from a high-speed solid state design, and memory 162 may be implemented in any or all of the following physical memory types: random access memory (RAM), FLASH RAM, or one or more hard disk drives.

Decoder 164 is a programmable digital signal processor that takes a digital data from memory (e.g., cache buffer 166), performs operations on the digital data, and passes it to another memory device (e.g., memory 162) or to an output interface 168. The operations to be performed on the data may include error correction, decompression, descrambling, decryption, digital watermarking, and playback. The algorithms and keys used for these operations are programmable remotely from the control station 12 through the control channel 18, ensuring that receiver unit 152 uses the most current and highest-performing algorithms and secure (i.e., uncompromised) keys.

Output interface 168 interoperates with television 156 according to any of a variety of formats, including analog video output (e.g., NTSC or PAL formats), S-Video, and digital video interface (DVI), and high definition content protection (DVI-HDCP) for high definition television (HDTV). When receiver 152 is separate from television 156, as illustrated in FIG. 14, any HDTV signal interfaces can employ industry standard encryption channels like the secure high-definition digital video interface and others. A receiver station 16 for providing professional or public display of videos or movies, as opposed to a receiver station 16 for private viewing, will have an additional interface (not shown) for digital movie projection in theaters.

Receiver unit 152 communicates with control channel 18 and control station 12 through a modem 170 and an associated interface 172. Control channel 18 operates as a forward channel in communications with control station 12, with the satellite downlink operating as the return channel. Control channel 18 may be implemented with a one-way over-the-air (OTA) paging system or as a two-way telephone link. Alternatively, an encrypted Internet protocol can also be implemented either as a one-way forward channel with satellite link return or as a two-way link.

Satellite VOD system 10 includes one or more security features to prevent unauthorized access to and copying of transmitted files or videos. The security features include any or all of authentication, access control, digital watermarking, rights revocation, structural anti-tamper designs, transient storage, dynamic algorithms and file encryption.

With authentication each communication from a user station 16 on control channel 18 is authenticated at the control station 12 using a unique user authentication code. These authentication codes can be periodically revoked or changed by the control station 12 using the control channel 18 if the customer system security has been compromised.

With access control user stations 16 require unique authorization codes to receive satellite file transmissions. Authorization codes are transmitted as part of a preamble of the satellite file transmission. Authorization codes are periodically reset on the user terminals 16 through control channel 18 to discourage security compromises. Authorization codes act as one-time access controls tied to each transmission. Because they are on the transmission preamble, these codes are difficult to intercept timely, and if somehow obtained without permission, are useless to access additional transmissions.
Digital watermarking provides unique identification of each file transmission. Digital watermarks have the qualities of being unique and survivable to digital manipulation and data tampering. Two digital watermarking systems are used to help identify the source of a security leak. One watermark is applied at the control center 12 to identify the actual file transmission, and another watermark is applied at the user station 16 to identify the receiver. The watermark applied at control center 12 distinctly identifies every uplink transmission file, and the identifying information is archived to provide a record or audit trail of the transmission. The user terminal 16 applies a digital watermark to the digital video as it plays, the watermark being generated from a unique code identifying the receiver and a timecode. If an illicitly copied or leaked file or video is discovered, such as in the marketplace, the digital watermarks can be extracted and relate the file or video to a specific VOD transmission and recipient with a high degree of certainty.

With rights revocation compromised systems can be disabled remotely by control station 12 using codes transmitted of control channel 18 or the satellite downlink.

Receiver station 16 has a structural anti-tamper design to discourage tampering. For example, receiver station 16 may be disabled if its case is opened or covers removed. In one implementation, switches or light sensors inside the case of receiver station 16 detect a physical breach, and energy from a storage capacitor or battery is used to clear the system memory 162 and the boot programming of the receiver. Tampered receivers cannot be reactivated through control channel 18. These receivers would have to be reconfigured at a maintenance and refurbishment facility. The receiver electronics can alternatively be incorporated as part of the display unit tuner, further protecting the system from unauthorized security breaches through interface ports.

With transient storage, receiver station 16 is configured to play the digital file directly from the cache memory 166 without transferring the file to a hard disk prior to playback. At the end of the playback, the file is completely erased from the receiver electronics. This feature can be implemented for valuable files, further discouraging security compromises.

To discourage security breaches, the algorithms and keys used for digital watermarking and decryption can be periodically changed from the control station 12 by reloading the receiver system memory at user stations 16 via control channel 18 or satellite downlink control messages.

Files stored memory 162 (e.g., hard disk) of user stations 16 may be encrypted using a key to permit playback only on a specific receiver 156. If the key is revoked by the control station 12, the files cannot be played. As an alternative to or in addition to file encryption, individual frames of the files can be reordered or scrambled in accordance with a process that works with the receiver key.

The proposed system is not limited to using the physical steering methods described above. In general, digital beam-forming and steerable antenna beams can also be used and may produce better results. In this implementation, the satellite 14 may use a transmit antenna array that can deliver one or more antenna beams with variable power. The transmitted power of each formed antenna beam can be changed by combining the outputs of multiple highly linear high-power amplifiers aboard the satellite 14. The size and direction of each formed antenna beam can also be changed by adjusting the amplitude and phase of the array's radiating elements.

Queue engine 94 uplinks commands to the satellite 14 to control the power, size, and direction of each formed antenna beam. Queue engine 94 controls the time duration over which a particular instance of the formed antenna beam exists. During the time in which a particular instance of the formed antenna beam exists, the control station 12 uplinks to the satellite 14 a transmission containing the video file to be delivered, dedicated or common, to the user or users located in a cell illuminated by the formed antenna beam.

To achieve ultra-high bandwidth, the system uses high frequency bands that suffer considerable attenuation in the atmosphere. To provide reliable reception of the satellite signal, the system uses link power control. The queue engine 94 in the control station 12 controls the power of the antenna beams in response to the path loss or losses experienced by the user or users located in the illuminated cells.

Control station 12 maintains a current map of path loss by cell. The queue engine 94 receives feedback from individual user terminals 16 through the control channel 18. Each user station 16 receives the downlink signal. The user station 16 detects the received strength of the downlink signal and regularly or on-demand reports the detected received strength to the queue engine 94 in the control station 12. The received strength of the downlink signal forms the basis of path loss computation by queue engine 94.

Besides uplink power control, the system may respond to weather-related outages by retransmitting a video file on a priority basis until a transaction is complete. Successful retransmission during weather outages is assisted by the brief downlink times and by file management in the receiver memory 162. The brief downlink times take advantage of short windows of opportunity when weather attenuation is reduced. The receiver can start playing as soon as it receives part of a file, expanding the reception window during which the rest of the file can be received and concatenated to the file in memory.

An optional pseudo-broadcast mode of operation can also be incorporated into this system architecture using broad coverage mode. In addition, by incorporating a short time delay, a live program can be broadcasted from the satellite 14. The live program is cached during the short time delay and a broadcast file is prepared at the control station 12 and broadcasted using broad coverage mode. While the program segment is playing in the user terminals, the system handles additional file requests while caching the next segment of the program. With proper time management, the program segments will play seamlessly while permitting file delivery to other clients.

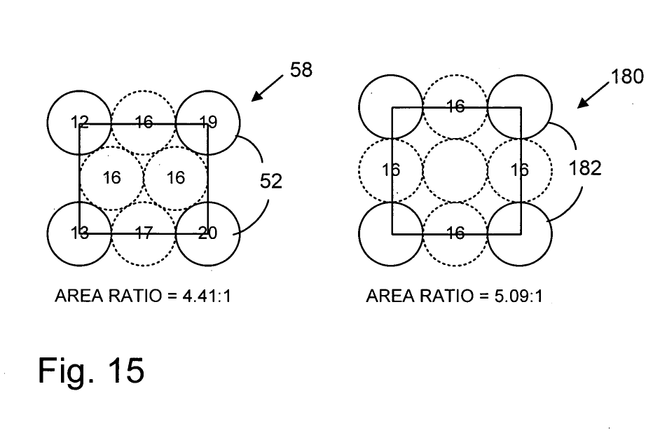

FIG. 15 illustrates an alternative virtual grid beam pattern 180 with regular square spacing of cells 182 in comparison to a segment of virtual grid 58 (FIG. 5) with cells 52. Cells 52 within virtual grid 58 of FIG. 15 have sample cell number designations for clarification. Likewise, cells 182 within virtual grid 180 have similar sample cell number designations. The beam grid patterns of virtual grid 58 can be formed with three positions of downlink reflector 42, as described above, while the beam grid patterns of virtual grid 180 would be formed with four positions of downlink reflector 42.

The triangular arrangement of virtual grid 58 provides a ratio of 4.41-to-1 between the area of a virtual grid and the area of the physical grid. In contrast, the square arrangement of the virtual grid 180 provides a ratio of 4.41-to-1. As a result, virtual grid 180 provides increased coverage relative to the physical grid. It will be appreciated, however, that for each such additional physical grid position there is a decrease in the overall bandwidth at each position.

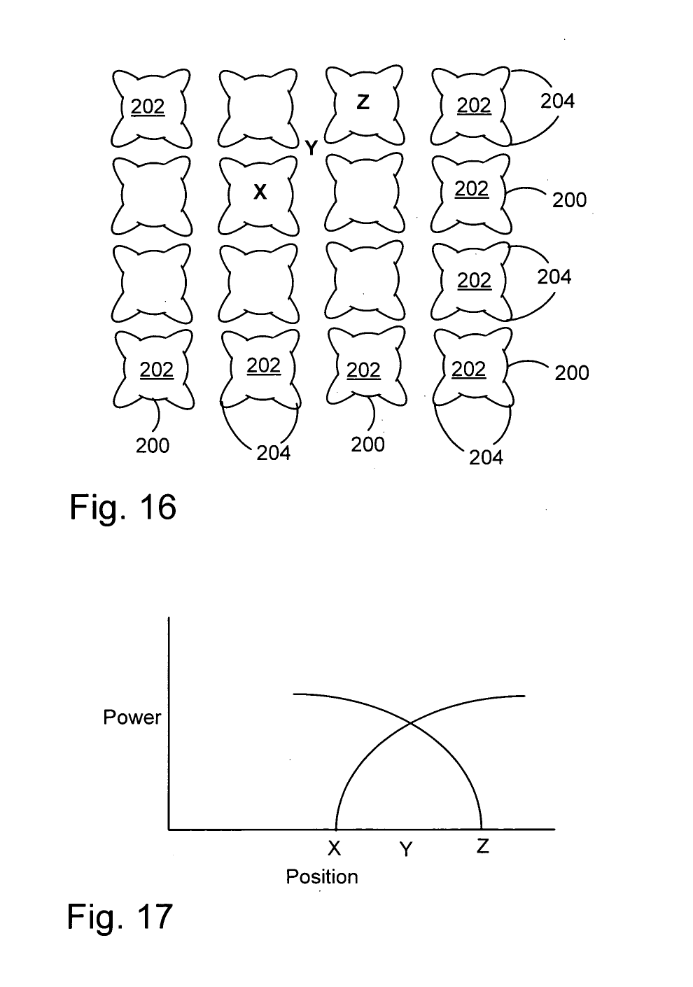

FIG. 16 is an illustration of an arrangement of alternative lobed cells 200 according to the present invention. Each lobed cell 200 includes a central core 202 and plural (e.g., four) lobes 204 that extend from central core 202. Lobed cells 200 can provide increased bandwidth or signal coverage to interstitial areas between the cells receiving a common beam or signal. As an illustration, FIG. 17 is a graph illustrating relative signal powers delivered by a lobed cell 200 designated X and a lobed cell 200 designated Z at an interstitial area designated Y. Lobed cells 200 can be formed, for example, by using in satellite 14 appropriate shaping of reflector 42, a phased array, or any other antenna arrangements.

In view of the many possible embodiments to which the principles of our invention may be applied, it should be recognized that the detailed embodiments are illustrative only and should not be taken as limiting the scope of our invention. Rather, we claim as our invention all such embodiments as may come within the scope and spirit of the following claims and equivalents thereto.

1. A satellite video on demand method using a satellite in earth orbit with at least one uplink and plural downlinks to plural cells distributed over a geographic region, the method comprising:
receiving at a control station plural requests for video files from plural users in plural cells in the geographic region, including first requests from plural first users in plural first cells for a first video file and second requests for one or more second video files from other users in one or more second cells;
accumulating the first requests over a first time period;
transmitting at least portions of the one or more second video files to the other users via the at least one uplink and one or more downlinks to the one or more second cells during the first time period; and
after the first time period, transmitting the first video file to the plural first users via the at least one uplink and plural simultaneous downlinks to the plural first cells.

2. The method of claim 1 in which the plural cells in the geographic region are arranged in an open array with interstices between the cells

3. The method of claim 1 further comprising transmitting the first video file as a first common downlink signal to the plural first cells so that the first common downlink signal between the cells in the first open array constructively interferes to deliver the first common downlink to the interstices.

4. The method of claim 1 in which the plural cells include plural third cells positioned in interstices between the plural first cells and the one or more second cells within the geographic region, the method further comprising repositioning the plural downlinks to direct them to the plural third cells after the first video file is transmitted to the plural first users.

5. The method of claim 4 in which the geographic region is a first geographic region and the plural cells include plural third cells positioned in second geographic region that is adjacent to and substantially non-overlapping with the first geographic region, the method further comprising further comprising repositioning the plural downlinks to direct them to the plural third cells after the first video file is transmitted to the plural first users.

6. The method of claim 1 in which the geographic region is a first geographic region and the plural cells include plural third cells positioned in second geographic region that is adjacent to and substantially non-overlapping with the first geographic region, the method further comprising further comprising repositioning the plural downlinks to direct them to the plural third cells after the first video file is transmitted to the plural first users.

7. The method of claim 1 in which transmitting the one or more second video files to the other users includes transmitting a dedicated video file to only one user.

8. The method of claim 1 in which transmitting the one or more second video files to the other users includes transmitting one dedicated video file separately to each of plural users.

9. The method of claim 1 in which each cell is generally circular.

10. The method of claim 1 in which each cell includes plural lobes that extend from a central core.

11. The method of claim 1 in which the satellite is in a geosynchronous earth orbit.

12. A satellite video on demand queuing method for use with a satellite in earth orbit having at least one uplink and plural downlinks to plural cells distributed over a geographic region, the method comprising:
receiving at a control station plural requests for video files from plural users in plural cells in the geographic region, including first requests from plural first users in plural first cells for a first video file and second requests for one or more second video files from other users in one or more second cells;
accumulating the first requests over a first time period;
transmitting at least portions of the one or more second video files to the satellite via the at least one uplink during the first time period for delivery to the other users; and
after the first time period, transmitting the first video file to the satellite for simultaneous delivery to the plural first users.

13. The method of claim 12 in which transmitting the one or more second video files includes transmitting a dedicated video file for delivery to only one user.

14. The method of claim 12 in which transmitting the one or more second video files includes transmitting one dedicated video file to be delivered separately to each of plural users.

15. A computer-readable medium with satellite video on demand queuing software for use with a satellite in earth orbit having at least one uplink and plural downlinks to plural cells distributed over a geographic region, the medium comprising:
software for receiving at a control station plural requests for video files from plural users in plural cells in the geographic region, including first requests from plural first users in plural first cells for a first video file and second requests for one or more second video files from other users in one or more second cells;
software for accumulating the first requests over a first time period;
software for transmitting the one or more second video files to the satellite via the at least one uplink during the first time period for delivery to the other users; and
software for transmitting the first video file to the satellite after the first time period.

16. The medium of claim 15 in which the software for transmitting the one or more second video files includes software for transmitting a dedicated video file for delivery to only one user.

17. The medium of claim 15 in which the software for transmitting the one or more second video files includes software for transmitting one dedicated video file to be delivered separately to each of plural users.

18. A satellite video on demand method using a satellite in earth orbit having at least one uplink and plural downlinks to plural cells distributed over a geographic region, the method comprising:
directing plural first downlinks to the plural cells arranged in a first open array of spaced-apart cells with interstices therebetween, the first downlinks carrying a first common downlink signal to the cells in the first open array so that the first common downlink signal between the cells in the first open array constructively interferes to deliver the first common downlink to the interstices; and
directing plural second downlinks to the plural cells arranged in a second open array of spaced-apart cells with interstices therebetween, the cells in the second open array being in the interstices between the cells in the first open array, the second downlinks carrying a second common downlink signal to the cells in the first open array so that the second common downlink signal between cells constructively interferes to deliver the first common downlink to the interstices between the cells.

19. The method of claim 18 in which directing plural first downlinks to the plural cells arranged in a first open array of spaced-apart cells further comprises:
receiving at a control station plural requests for video files from plural users in plural cells in the first open array, including first requests from plural first users in plural first cells in the first open array for a first video file and second requests for one or more second video files from other users in one or more second cells in the first open array;
accumulating the first requests over a first time period;
transmitting at least portions of the one or more second video files to the other users via the at least one uplink and one or more downlinks to the one or more second cells during the first time period; and
after the first time period, transmitting the first video file to the plural first users via the at least one uplink and plural simultaneous downlinks to the plural first cells.

20. The method of claim 19 further comprising transmitting the first video file as a first common downlink signal to the plural first cells so that the first common downlink signal between the cells in the first open array constructively interferes to deliver the first common downlink to the interstices.

21. The method of claim 19 in which the plural cells include plural third cells positioned in interstices between the plural first cells and the one or more second cells within the geographic region, the method further comprising repositioning the plural downlinks to direct them to the plural third cells after the first video file is transmitted to the plural first users.

22. The method of claim 19 in which transmitting the one or more second video files to the other users includes transmitting a dedicated video file to only one user.

23. The method of claim 19 in which transmitting the one or more second video files to the other users includes transmitting one dedicated video file separately to each of plural users.

24. A satellite file-on-demand method using a satellite in earth orbit with at least one uplink and plural downlinks to plural cells distributed over a geographic region, the method comprising:
receiving at a control station plural requests for files from plural users in plural cells in the geographic region, including first requests from plural first users in plural first cells for a first file and second requests for one or more second files from other users in one or more second cells;
accumulating the first requests over a first time period;
transmitting at least portions of the one or more second files to the other users via the at least one uplink and one or more downlinks to the one or more second cells during the first time period; and
after the first time period, transmitting the first file to the plural first users via the at least one uplink and plural simultaneous downlinks to the plural first cells.
